(19) United States
(12) Patent Application Publication
(10) Pub. No.: US 2009/0240956 A1
(43) Pub. Date: Sep. 24, 2009

(54) Transparent encryption using secure encryption device

(75) Inventors: Brian Metzger, San Jose, CA (US); Stephen Mauldin, San Francisco, CA (US); Bruce Sandell, Mountain View, CA (US); Jorge Chang, Santa Clara, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: SafeNet, Inc.

(21) Appl. No.: 12/387,903

(22) Filed: May 8, 2009

Related U.S. Application Data
(62) Division of application No. 11/236,061, filed on Sep. 26, 2005.

(51) Int. Cl. G06F 12/14

(52) U.S. Cl. 713/193

(57) ABSTRACT

A system and method for allowing application programs that are external to the relational database to access the sensitive data in the database in a seamless fashion are described. The application programs are allowed to use existing query statements without having to modify such statements for accessing encrypted data in the relational database.

### CROSS-REFERENCE TO RELATED APPLICATIONS

The present application is a continuation of U.S. patent application Ser. No. 11/236,061 filed on Sep. 26, 2005, which is incorporated herein by reference in its entirety. The present application is also related to the following applications, the entire contents of which are hereby incorporated by reference as if fully set forth herein: U.S. patent application Ser. No. 11/236,294 filed on Sep. 26, 2005 entitled DATA MIGRATION; and U.S. patent application Ser. No. 11/236,046 filed on Sep. 26, 2005 entitled KEY ROTATION.

### TECHNICAL FIELD

The present invention is directed to data security, and more specifically to protecting sensitive data that resides in a database and allowing authenticated application programs to access the sensitive data in a manner that is transparent to the application programs and the database.

### BACKGROUND

It cannot be gainsaid that confidential information, such as credit card numbers, social security numbers, patient records, insurance data, etc., need to be protected. Although enterprises have instituted procedures for protecting such sensitive data when such data is in transit, more often than not, such data is stored in unencrypted format (“clear text” or “plain text”). For example, data is often stored as clear text in databases. The clear text is visible to attackers and disgruntled employees who can then compromise the data and/or use the data illegitimately. Further, not only is data security a feature that is highly desired by customers but it is also needed to comply with certain data security regulations. In order to adequately protect data, organizations need to institute procedures to protect data at all times including when the data is in storage, when the data is in transit, and when the data is being used.

It is also desirable to have the ability to selectively encrypt certain database tables in a given database and/or certain columns of the database tables rather than encrypting all of the columns of all of the database tables. However, to provide encryption at a granular level, such as at the column level for a database table, requires extensive changes to the application programs that wish to access the encrypted data in the given database. Such an approach is inconvenient and would require considerable time and effort to implement such a solution.

### BRIEF DESCRIPTION OF THE DRAWINGS

FIG. 1 is a high-level block diagram that illustrates a system architecture for transparent encryption, according to certain embodiments.

FIG. 2 is a flowchart that illustrates some of the steps that are performed for converting sensitive data that is stored in clear text format in a relational database into encrypted format in a manner so as to allow application programs that access the relational database to interact with a cryptography server for performing cryptography operations in a manner that is transparent to the application programs, according to certain embodiments.

FIG. 3 is a flowchart that illustrates some of the steps that are performed for allowing an application program to access encrypted data in a database without modification to query statements sent by the application program for accessing such encrypted data, according to certain embodiments.

FIG. 4 is a flowchart that illustrates some of the steps for executing an insert query statement issued by the user on a populated instantiated view that contains requested sensitive data, according to certain embodiments.

FIG. 5 is a flowchart that illustrates some of the steps for executing an update query statement issued by the user on a populated instantiated view that contains requested sensitive data, according to certain embodiments.

### DETAILED DESCRIPTION

According to certain embodiments, an unsecured database system is converted to a secure system by providing mechanisms for converting existing data that resides in the relational database into encrypted format. Further, according to certain embodiments, a mechanism is provided to allow for granular protection of sensitive data in the database. In other words, certain tables in the database can be selected for encryption. If desired, certain columns in a given database table can be selected for encryption, rather than encrypting the entire database table. Such granular protection is implemented with minimal impact to the database and the application programs that access data in the database. Authorized application programs can seamlessly access encrypted data with little or no change to the application program.

According to certain embodiments, a mechanism is provided to allow application programs that are external to the relational database to access the sensitive data in the database in a seamless fashion. To explain, the application programs should be allowed to use existing query statements that are normally used for accessing non-encrypted data without having to modify such statements for accessing encrypted data in the relational database. In other words, the application programs can use the same query statements that were used for accessing the sensitive data in the database before the sensitive data was encrypted.

According to certain embodiments a mechanism is provided for allowing the management of a seamless interaction between the relational database and the one or more mechanisms for: 1) encrypting and decrypting data on demand from inside the relational database, 2) migrating data from plaintext columns to encrypted columns, 3) automating subsequent encrypt and decrypt operations, 4) authenticating users so that only authorized users are able to access sensitive data.

According to some embodiments, when an authorized application program makes requests to access sensitive data that is already encrypted in a given source database table, a view of the source table is instantiated using metadata tables. Further, the requested sensitive data is decrypted and such a view is populated with the decrypted sensitive data. Any actions executed by the requesting application program on the view are captured. In response to the captured actions, new actions are automatically executed on the corresponding source table as if the requesting application was acting directly on the corresponding source table.

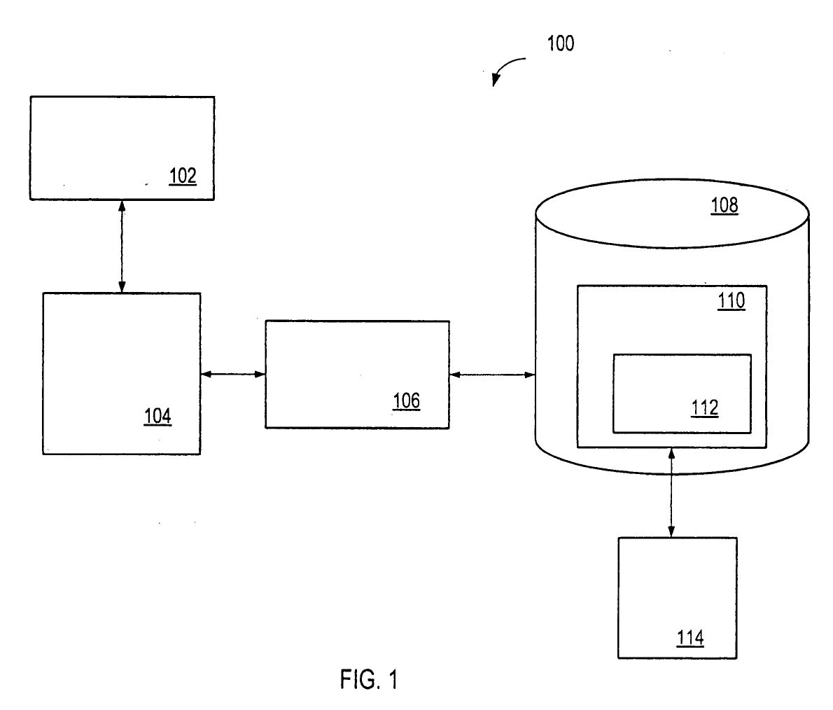

FIG. 1 is a high-level block diagram that illustrates a system architecture for transparent encryption, according to certain embodiments. In architecture 100, a client computer 102 can access, through a web server 104, an application server 106. Application server 106 can communicate with a relational database 108. Relational database 108 includes a database provider 110 and a cryptography provider 112. Database provider 110 and cryptography provider 112 are capable of communicating with a cryptography server 114. Cryptography server 114 is also referred to as a network-attached cryptography server (NAE server).

According to certain embodiments, the database provider, such as database provider 110, is a PL/SQL (Procedural Language/Structured Query Language) layer that comprises several functions for exposing features of a given cryptography provider to a given relational database. Such functions include but are not limited to: 1) function for setting system properties that the cryptography provider may need such as setting the location of client certificate key store and password, 2) function for setting the cryptography server user name and password for a specific user of the relational database, 3) optional function for encrypting a string and returning the data as a Base64 encoded string, 4) optional function for decrypting Base64 encoded string and returning the original unencrypted string, 5) optional function for encrypting a number and returning the data as a Base64 encoded string, 6) optional function for decrypting Base64 encoded string and returning the original unencrypted number, 7) optional function for encrypting a string and returning the data as a raw binary, 8) function for decrypting a raw binary and returning the original unencrypted string, 9) function for encrypting a number and returning the data as a raw binary, 10) function for decrypting a raw binary and returning the original unencrypted number, 11) function for encrypting a string and returning the data as bit data, 12) function for decrypting bit data and returning the original unencrypted string, 13) function for encrypting a number and returning the data as bit data, and 14) function for decrypting bit data and returning the original unencrypted number.

According to certain embodiments, the cryptography server, such as the NAE server, listens for client connections and manages cryptography operations and encryption key management operations. The cryptography server allows a user or cryptography server client to perform cryptography operations including operations associated with encryption keys, authentication, encryption and decryption of data, create digital signatures, generation and verification of Message Authentication Code (MAC).

The cryptography server allows a cryptography server client to perform cryptography operations through the cryptography provider. The cryptography provider is the API to the cryptography server, according to certain embodiments. It is the cryptography provider that communicates with the cryptography server to request for cryptography services.

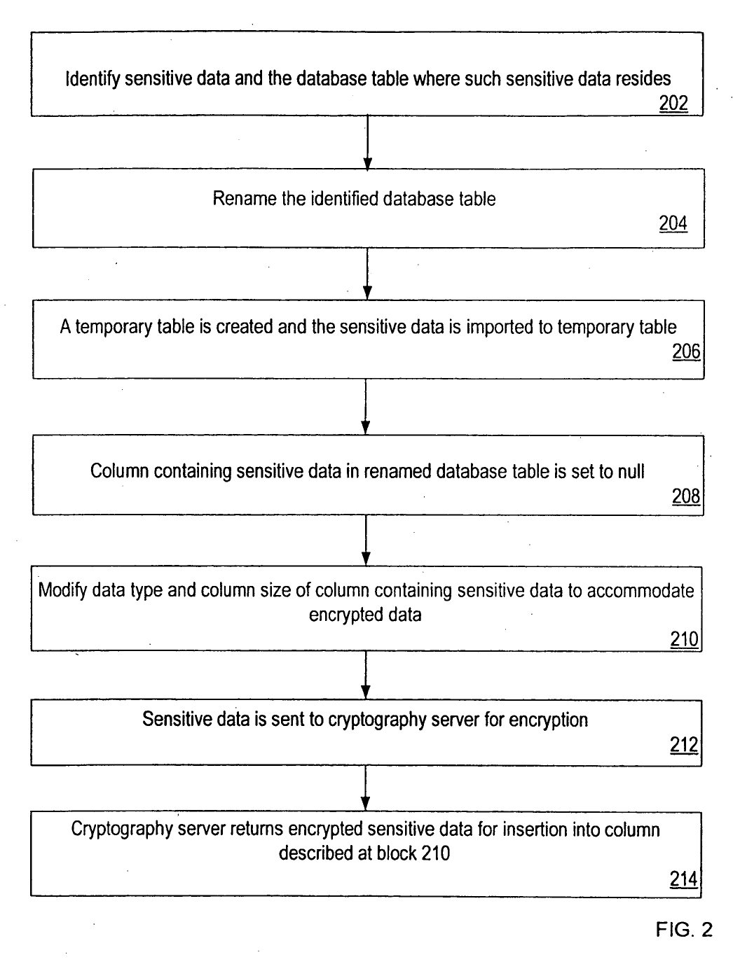

FIG. 2 is a flowchart that illustrates some of the steps that are performed for converting sensitive data that is stored in clear text format in a relational database into encrypted format in a manner so as to allow application programs that access the relational database to interact with a cryptography server for performing cryptography operations in a manner that is transparent to the application programs, according to certain embodiments. At block 202, sensitive data is identified and the database table where such sensitive data resides is identified. The identified database table where such sensitive data resides is herein referred to as the source table. For purposes of explanation in reference to FIG. 2, assume that a database table called “CUSTOMER” includes sensitive data (credit card numbers) in a column called CC_NUM, as shown in Table 1, herein.

TABLE 1
CUSTOMER

| Name | CC_Num | Address | City | State | Zip |
|---|---|---|---|---|---|
| Irwin M. Fletcher | 1234567890123456 | 411 Main Street | Santa Barbara | CA | 93101 |
| Josh Ritter | 1111222233334444 | 1801 21st Ave | San Francisco | CA | 94122 |
| Steve Garvey | 4444333322221111 | 123 First Ave | Brentwood | CA | 90049 |

At block 204, source table “CUSTOMER” is renamed so that a view can be created later with the same name, “CUSTOMER”. Assume that the source table “CUSTOMER” is renamed to “CUSTOMER_ENC” as shown in Table 2, herein. However, data in column CC_NUM in the renamed source table “CUSTOMER_ENC” as shown in Table 2 has not yet changed but will change in a manner as described at block 210.

TABLE 2

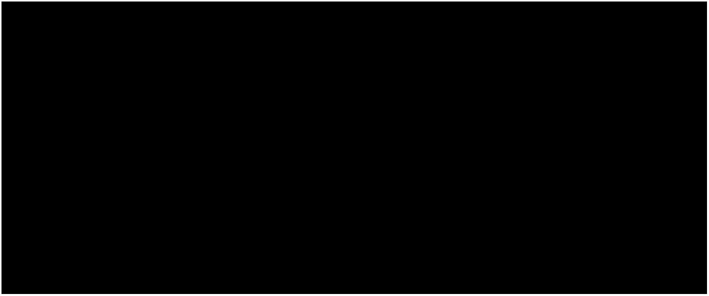

At block 206, a temporary table is created and the sensitive data from column CC_NUM from the renamed source table, CUSTOMER_ENC, is exported to the temporary table. After exporting the sensitive data to the temporary table as described at block 206, at block 208, the data in column CC_NUM in CUSTOMER_ENC are set to null to avoid any data conversion that might arise when changing the data type at a later step. An example of temporary table is shown in TABLE 3 as CUSTOMER_TEMP, herein.

TABLE 3

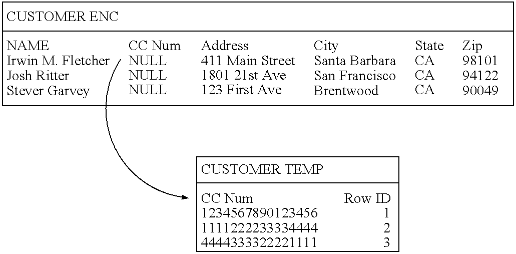

At block 210, the data type and column size of column CC_NUM are modified to accommodate encrypted data because encrypted data is predictably larger than clear text data. As a non-limiting example, the encrypted data can be stored in Base64 encoded format or as binary data. After the data type and column size of column CC_NUM have been modified, and before the sensitive data from temporary table, CUSTOMER_TEMP, is imported back into CUSTOMER_ENC, at block 212, the cryptography provider sends the sensitive data from the temporary table to cryptography server where the sensitive data is encrypted.

At block 214, the cryptography server returns the encrypted sensitive data to the cryptography provider. The cryptography provider inserts the encrypted sensitive data into column CC_Num of the renamed source table, CUSTOMER_ENC. The source table that includes encrypted data may appear as shown in Table 4, herein.

TABLE 4
CUSTOMER_ENC.

| Name | CC_Num | Address | City | State | Zip |
|---|---|---|---|---|---|
| Irwin M. Fletcher | ZaolYGppn6b9IKO==s//CsD | 411 Main Street | Santa Barbara | CA | 93101 |
| Josh Ritter | cS8Bxb/EXA0RImRAfVnEh0ce | 1801 21st Ave | San Francisco | CA | 94122 |
| Steve Garvey | Ly1EIo0Pk#nmZkDqB2AWGA1U | 123 First Ave | Brentwood | CA | 90049 |

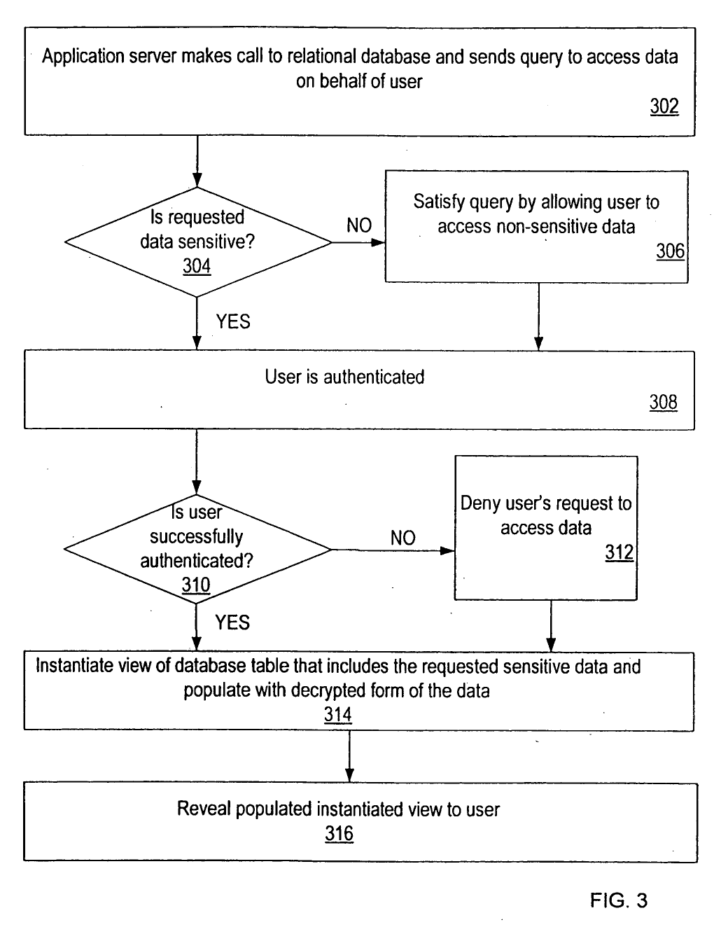

FIG. 3 is a flowchart that illustrates some of the steps that are performed for allowing an application program to access encrypted data from a database without modification to query statements sent by the application for accessing such encryption data, according to certain embodiments. For purposes of explanation, assume that a user wishes to access sensitive data that is stored in encrypted format in a relational database. The sensitive data that the user requests to access is herein after referred to as “requested sensitive data.” FIG. 3 is described herein in reference to FIG. 1. In reference to FIG. 1, the user can use client computer 102 to access application server 106 via the web server 104. Application server 106 manages at least one application program (not shown in FIG. 1) for accessing data from relational database 108. Assume that application server 106 and the at least one application program are agnostic as to the encrypted format of the sensitive data stored in relational database 108. Even though the requested sensitive data is encrypted, the application server 106 and the associated application program operate as if the sensitive data is in clear text format.

At block 302 of FIG. 3, the application server makes a call to the relational database and sends a query to request access to data in the database on behalf of the user. At block 304, a decision is made as to whether the requested data is sensitive data. If it is determined that the requested data is not sensitive data, then at block 306, the query is satisfied by allowing the user to access the non-sensitive data.

However, if it is determined that the requested data is sensitive data, then at block 308, the user is authenticated to the cryptography server through the cryptography provider. In a non-limiting example of authentication, the user is asked for a valid user name and password. In another non-limiting example of authentication, in addition to being asked for a valid user name and password, the user may be asked for a client certificate. In another non-limiting example, the user's credentials are stored in the relational database, and thus can be retrieved from the database.

At block 310, it is determined if the user is successfully authenticated. If it is determined that the user is not successfully authenticated, then at block 312, the user's request to access data is denied.

However, it is determined that the user is successfully authenticated, then at block 314, the database provider automatically instantiates a view of the database table that contains the requested sensitive data and populates the instantiated view with the decrypted form of the requested sensitive data. According to certain embodiments, such a view is instantiated using metadata tables. At block 316, the populated instantiated view is revealed to the user. The user can then interact with the revealed view. Returning to the example described in reference to FIG. 2, an example of a populated view is shown in Table 5, herein.

TABLE 5

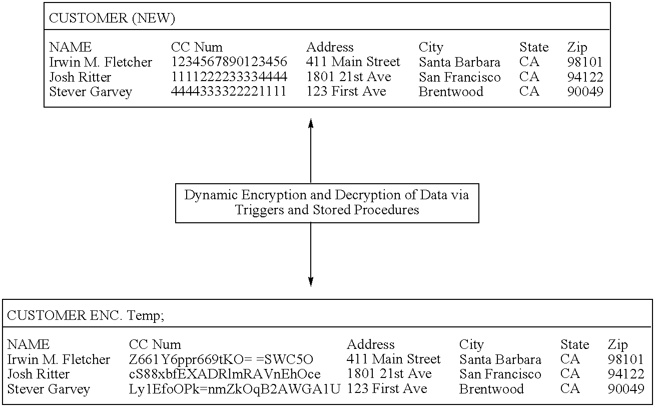

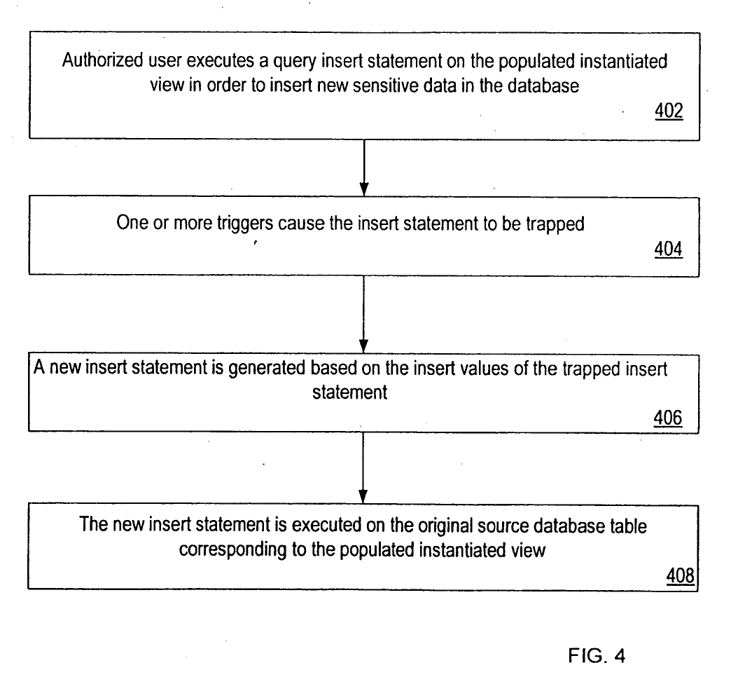

FIG. 4 is a flowchart that illustrates some of the steps for executing an insert query statement issued by the user on a populated instantiated view that contains requested sensitive data, according to certain embodiments.

At block 402 in FIG. 4, the authorized user executes a query insert statement on the populated instantiated view in order to insert new sensitive data into a given database table in the relational database. Because the populated instantiated view has the same name as the corresponding original source database table, the query statements that reference an encrypted column or encrypted data can function regularly without modification.

At block 404, in response to the authorized user's attempt to execute the insert statement on the view, one or more triggers cause the user's insert statement to be trapped. At block 406, a request is made to the NAE server for encryption to be performed so that a new insert statement can be generated based on the insert values of the trapped insert statement. In other words, the NAE server performs encryption on the insert values. At block 408, the new insert statement is executed on the corresponding source database table corresponding to the populated instantiated view.

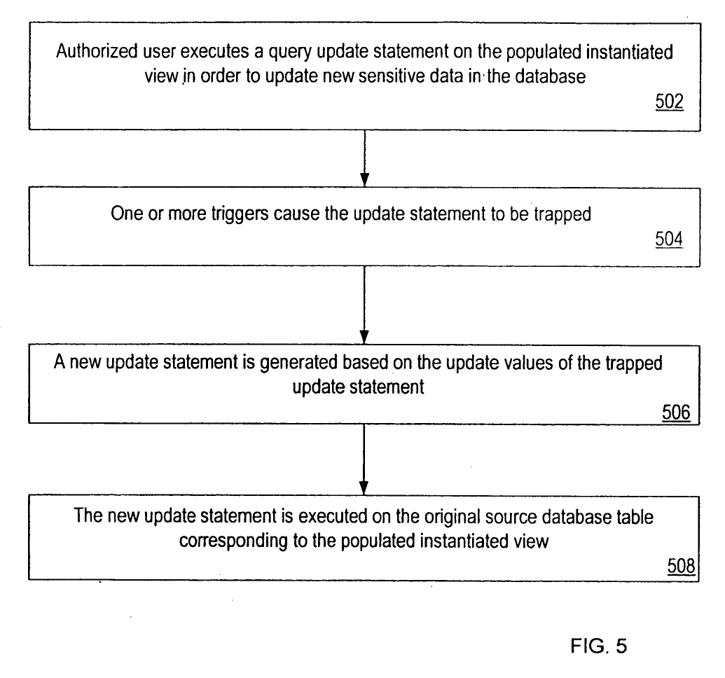

FIG. 5 is a flowchart that illustrates some of the steps for executing an update query statement issued by the user on a populated instantiated view that contains requested sensitive data, according to certain embodiments.

At block 502 in FIG. 5, the authorized user executes a query update statement on the populated instantiated view in order to update new sensitive data into a given database table in the relational database. Because the populated instantiated view has the same name as the corresponding original source database table, the query statements that reference an encrypted column or encrypted data can function regularly without modification.

At block 504, in response to the authorized user's attempt to execute the update statement on the view, one or more triggers cause the user's update statement to be trapped. At block 506, a new update statement is generated based on the update values of the trapped update statement. At block 408, the new update statement is executed on the original database table corresponding to the populated instantiated view.

In the foregoing specification, embodiments of the invention have been described with reference to numerous specific details that may vary from implementation to implementation. The specification and drawings are, accordingly, to be regarded in an illustrative rather than a restrictive sense.

We claim:

1. A transparent encryption system for encrypting data in a database, the transparent encryption system comprising:
means for encrypting and decrypting data on demand from within said database in order to integrate said database into said transparent encryption system;
means for migrating data from one or more plaintext database table columns to corresponding one or more encrypted database table columns;
means for automating subsequent encrypt and decrypt operations on said database after integrating said database into said transparent encryption system; and
means for authenticating users so that only authorized users are able to access encrypted data in said integrated database.
